(19) United States
(12) Patent Application Publication
(10) Pub. No.: US 2014/0306602 A1
(43) Pub. Date: Oct. 16, 2014

(54) HIGH-FREQUENCY LAMP AND METHOD FOR OPERATING A HIGH-FREQUENCY LAMP

(71) Applicant: DRITTE PATENTPORTFOLIO BETEILIGUNGSGESELLSCHAFT MBH & CO. KG, Schonefeld/Waltersdorf (DE)

(72) Inventors: Holger Heuermann, Aachen (DE); Rainer Kling, Dossenheim (DE); Stepfan Holtrup, Linnich (DE)

(73) Assignee: Dritte Patentportfolio Beteiligungsgesellschaft MBH & Co. KG, Schonefeld/Waltersdorf (DE)

(21) Appl. No.: 14/357,802

(22) PCT Filed: Nov. 16, 2012
(86) PCT No.: PCT/EP2012/072888

§ 371 Date: May 13, 2014

(30) Foreign Application Priority Data
Nov. 18, 2011 (DE) 10 2011 055 486.6

(51) Int. Cl. H01J 65/04

(52) U.S. Cl. CPC H01J 65/048
USPC 315/34

(57) ABSTRACT

The invention relates to a high-frequency lamp with a glass bulb and a device for supplying a high-frequency signal. High-frequency lamps known in the prior art either have been limited to a narrow selection of substances in the glass bulb or have relied on a heating process using a spiral-wound filament or the like. The aim of the invention is to provide an inexpensive and more efficient high-frequency lamp. This is to be achieved in particular in that the glass bulb is made, for example from window glass, so as to be heatable by the heat losses of the high-frequency signal in the glass bulb such that even metal halogenides for example can be evaporated without an additional heating process.

The invention relates to a radio-frequency lamp as claimed in claim 1, a method for operating a radio-frequency lamp as claimed in claim 9 and a use of glass as claimed in claim 13 and a use of a radio-frequency signal as claimed in claim 14.

Lamps are generally intended to emit light as efficiently as possible with the best possible color spectrum. Every lamp converts energy into light with a reasonably good efficiency. Often there is a very great deal of heat loss that arises during the conversion. In general, the emitted light spectrum and its emission behavior are instrumental with regard to the purpose of use. Fluorescent lamps and gas discharge lamps are known from the prior art.

Gas discharge lamps are light sources which use a gas discharge and in this case utilize the spontaneous emission as a result of atomic or molecular electronic transitions and the recombination radiation of a plasma generated by electrical discharge. The gas contained in the quartz glass bulb (ionization chamber) is generally a mixture of metal vapors (e.g. mercury) and noble gases (e.g. argon) and, if appropriate, other gases such as halogens as well. Gas discharge lamps are subdivided into the two classes of low- and high-pressure discharge lamps. The former class uses a corona discharge, and the latter an arc discharge.

These lamps all require a ballast. The conventional ballast of a fluorescent lamp contains an inductor and a bimetal contact as a starter circuit. The inductor is used for the start as a series resistor for the fluorescent tube (often called ionization chamber here). This simple circuit is designed for operation at 50 Hz.

Modern compact energy-saving lamps use electronic ballasts. Said electronic ballasts afford many advantages over the conventional ballast. Inter alia, the structural size is reduced and the efficiency is improved. An electronic ballast consists e.g. of a bridge rectifier, control electronics, an inverter having two power transistors and a resonant circuit. The two transistors of the inverter are operated with opening times of around 45% in order that a short-circuit current can never flow to ground. These 45% times require special control electronics. The changeover times of the inverter are in the kHz range. As a result, the component sizes of the resonator are reduced immensely compared with the inductor of the conventional ballast. The improvement in efficiency largely originates from the fact that few loss recombinations occur on account of the higher frequency. This effect is also designated as RF gain (RF=radio-frequency).

A special form of the gas discharge lamp is the sulfur lamp. It consists of a quartz glass sphere filled with sulfur and argon. A plasma is generated in the glass sphere by radio-frequency irradiation. The ballast contains a magnetron, which has a lower durability than other lamp ballast techniques on account of the finite lifetime of the greatly heated cathode.

The sulfur lamp stands out against the other gas discharge lamps by virtue of the fact that it has a very high color temperature and thus has an almost white light spectrum. However, the technology for this lamp is very complex and thus expensive. Moreover, it is available only as a power lamp having high wattages in the kW range.

Furthermore, radio-frequency lamps (RF lamps) are known, which are often operated at 2.45 GHz. These lamps operate with low radio-frequency powers (30-200 W) and use, instead of the waveguide coupling, a coupling via a transverse-electromagnetic line (coaxial line) to the inner conductor electrode. Since these lamps use the long wires of a gas discharge lamp as an antenna, these lamps will be designated hereafter more appropriately as RF antenna lamps. In the case of these lamps as also in the case of sulfur lamps, the requirements made in respect of a frequency stability of the RF generator are low. Although the RF antenna lamps manage without a circuit for ignition, they require very much power (more than 30 W microwave power). Furthermore, both concepts use conventional gas discharge lamps in the form of antennas. This has the serious disadvantage in practice that radio-frequency radiation is emitted to a higher extent.

Significantly higher plasma efficiencies and thus also luminous efficiencies (measured in lumens per watt) are obtained with RF lamps which have highly effective impedance transformers. By means of these transformers, the voltage is stepped up in the coupling-in and the ionization is thus achieved at lower electrical powers. Such an RF lamp is known from DE 10 2007 057 581 A1, for example.

Traditional gas discharge lamps use an arc discharge and, in particular in the case of low-pressure lamps, the ionized plasma as a resistive load for the low-frequency signals into the kHz range.

RF lamps can be configured as a micro plasma lamp. The plasma is often generated at 2.45 GHz. It forms as a sphere around the supply electrode in the case of the asymmetrical supply often chosen. The linking to ground is purely capacitive.

Books about fundamental physical principles teach that the ionization of a gas takes place only by means of electron collision ionization, excited by an electron beam injection, thermal ionization at extremely high temperatures (10⁶K) or photoionization by means of ultraviolet light. Furthermore, in the GHz range on the basis of experimental physics the inventor has realized many set-ups by means of which ionized regions arose via the supply of relatively little radio-frequency energy at 2.45 GHz.

If an ionized gas has the same number of electrons and ions, then it is a gas that on average is free of space charge and is called a plasma.

Furthermore, Maxwell's equations can be used to show that the following mathematical relationships hold true for an ionized gas:

Relative permittivity:

∈ᵣ=1−(Ne²/∈₀/m/(ν²+ω²) (1)

Relative conductivity:

κ=(Ne²ν)/m/(ν²+ω²) (2)

Plasma frequency:

ωp={square root over ((Ne²/m/∈₀)}) (3)

with the following variables:
N: Number of electrons per volume,
e: Charge of an electron,
m: Mass of an electron,
∈₀: Electric field constant,
ν: Frequency of the collisions of the electrons with the gas molecules,
ω: Frequency of the radio-frequency signal.

Detailed investigations show that below the plasma frequency no electromagnetic energy can propagate in the plasma and no losses take place in the plasma. By contrast, space has a real field wave impedance Z_{f} above the plasma frequency. Z_{f} falls toward higher frequencies and exponentially approaches the free space impedance Z₀ of around 377Ω. That is to say that at higher frequencies the voltages required to implement the same powers are lower than at lower frequencies.

Equation (2) shows that the (small) resistance and thus the losses rise as the frequency increases. Consequently, the gases can be heated better at higher frequencies. In an analysis of the atmosphere for the transmission properties of the RF signals it is evident that in the two- to three-digit MHz range the radiation is virtually not absorbed at all, while at 50 GHz the entire radiation is damped as molecular absorption in hydrogen and/or oxygen.

In the lower MHz range it is possible to use so-called Tesla transformers in order thus to produce 100 W generators having an output voltage of 5 kV and thus to generate spark gaps having a length of 10 cm in air. The inventor has already generated micro plasma regions having a length of 1 cm at 2.45 GHz by means of a 10W transmitter and a voltage of 2 kV.

DE 10 2007 057 581 A1 describes a radio-frequency lamp comprising an ionization chamber and a first electrode, which projects into the ionization chamber. The ionization chamber contains a gas suitable for being excited to emit light. The electrode transmits an electrical signal to the gas in the ionization chamber in order to generate a plasma in the ionization chamber. Control electronics for generating the electrical signal are connected to the first electrode.

Said control electronics comprise a radio-frequency oscillator, at the output of which is arranged a power amplifier for raising the power of the radio-frequency signal. An impedance transformer is connected downstream of the power amplifier, the electrode via which the electrical signal is transmitted to the gas being situated at the output of said impedance transformer.

The glass bulb of the radio-frequency lamp in accordance with DE 10 2007 057 581 A1 is produced from quartz glass as in the case of traditional gas discharge lamps. A metal vapor mixture is situated within this quartz glass bulb. The composition of the gas metal vapor mixture is not specified further; in principle, mercury is appropriate, however, which is also used as standard in traditional gas discharge lamps. Mercury already evaporates at room temperature and is toxic in particular in the gaseous state. Furthermore, the light emitted by mercury atoms is perceived as unpleasant and artificial. Therefore, attempts are being made to replace mercury, e.g. by metal salts, for example sodium salts. Radio-frequency lamps which operate with such metal salts as luminophore contain no toxic substances and emit a multi-line spectrum. The emitted light is perceived as pleasant owing to its continuity and likewise improves the color rendering index, which is important for realistic rendering of colors. In contrast thereto, traditional gas discharge lamps (in particular low-pressure discharge lamps) are line emitters that do not emit a continuous spectrum.

What is problematic in connection with radio-frequency lamps which operate with metal salts as luminophore, however, is the high temperature required to convert the salts into the gaseous state. For this purpose, it is necessary to heat a glass bulb of the radio-frequency lamp, the metal salt being situated in said glass bulb. In this case, by way of example, it is conceivable in principle to heat the glass bulb by means of thermal radiation. Such heating is comparatively inefficient, however. In particular, it would be necessary to develop an additional unit which heats a wall of the glass bulb besides the conventional ignition and the operation of the lamp. Heating by means of an incandescent filament, for example, is also comparatively complex.

Conversion into the gaseous state is in any case absolutely necessary for operating a radio-frequency lamp, since it is only when the energy level has been correspondingly raised that the energy is expended to excite the gases or salts, such that light is emitted.

The invention is based on the problem of proposing a radio-frequency lamp and a method for operating a radio-frequency lamp which result in comparatively low burdens for the environment and in particular can be produced and operated with little outlay.

This problem is solved by means of a radio-frequency lamp as claimed in claim 1, a method for operating a radio-frequency lamp as claimed in claim 9 and a use of glass as claimed in claim 13 and a use of a radio-frequency signal as claimed in claim 14.

The problem is solved in particular by a radio-frequency lamp, comprising at least one glass bulb and at least one radio-frequency signal feeding device for feeding a radio-frequency signal having a predetermined frequency of preferably 10 MHz to 100 GHz to at least one contact region of at least one glass bulb, wherein the glass bulb contains a substance that is ionizable by the radio-frequency signal in the gaseous state, and said glass bulb, at least in sections, consists of a glass that has on average a loss factor tan δ of at least 2×10⁻⁴, preferably at least 5×10⁻⁴, more preferably at least 20×10⁻⁴, even more preferably at least 50×10⁻⁴, measured at a reference temperature of 20° C. and with a reference signal of 1 MHz. Furthermore, a transparent housing, in particular a second, outer glass bulb (or envelope bulb) is provided, in which the first glass bulb is arranged.

A central concept of the invention is that, rather than the quartz glass used in the prior art and having a loss factor tan δ of (approximately) 1×10⁻⁴, a glass having a higher loss factor of in particular at least 2×10⁻⁴ is used for the glass bulb. As a result, the glass bulb can be heated by the radio-frequency signal to a temperature, for example of at least 40° C., in particular of at least 120° C., preferably of at least 150° C., more preferably of at least 200° C., at which metal salts, e.g. sodium salts or lithium iodide, start to evaporate, which is crucial for the operation of the lamp. The reason for heating the glass resides in the frequency and in the loss factor tan δ of the dielectric, in this case glass. The higher the frequency and the higher the loss factor, the more electrical energy is converted into heat in the glass. This phenomenon can be observed in microwave ovens, in which glass is heated comparatively uniformly by the electromagnetic waves. In this case, a virtually unimpeded increase in temperature of the entire glass product is made possible by rotation. The heating process can be improved further by means of the transparent housing, in particular since a thermal insulation is provided. As a result, the efficiency during the operation of the radio-frequency lamp can be increased further.

The power of the radio-frequency signal can be for example in the range of 0.1 W to 100 W, in particular 5 W to 80 W, preferably 10 W to 30 W. A surface area of the glass bulb can be preferably 4 cm² to 200 cm², more preferably 10 cm², to 100 cm². The thickness of a wall of the glass bulb can be for example 0.1 mm to 2.0 mm, preferably 0.2 mm to 5.0 mm.

The substance can comprise at least one metal and/or at least one halide and/or at least one noble gas, in particular can consist of a metal-halogen-noble gas mixture.

For a glass loss angle of tan δ of at least 2×10⁻⁴, various glass variants can be taken into consideration. In general the term “glass” can also encompass special ceramics or quartz glasses having a correspondingly high loss angle (for example produced by impurities).

In accordance with a more general concept of the invention, which is claimed independently, it is proposed that a radio-frequency lamp be equipped with a radio-frequency signal generating device and a glass bulb, wherein the generatable power and frequency of the radio-frequency signal that can be fed to the glass bulb and the structural design of the glass bulb, in particular with regard to its area, its geometry, its thickness and/or its material composition, are coordinated with one another in such a way that the glass bulb can be heated at least in regions to a temperature of at least 40° C., in particular at least 120° C., preferably at least 150° C., more preferably at least 200° C., by the radio-frequency signal.

With low-frequency signals in the kHz range such as are used for the operation of conventional gas discharge lamps, efficient heating cannot be made possible since the losses of the glass at low frequencies are too small and, moreover, quartz having an extremely low loss factor of tan δ=1×10⁻⁴ are also used as standard in conventional gas discharge lamps.

In the case of the radio-frequency lamp according to the invention, in contrast to known radio-frequency lamps, the radio-frequency signal is now used not only for ionizing and exciting the gas in the glass bulb, but also at the same time for heating the wall of the glass bulb to the required temperature of at least 40° C. As a result, the radio-frequency lamp can be produced and operated in a comparatively simple manner. The use of mercury is not absolutely necessary. The hazard for the environment and human beings is also reduced as a result. In this connection, the use of a glass of “lower quality” (for example “window glass”) having a loss factor tan δ of at least 2×10⁻⁴ was also deliberately provided counter to the trend in the prior art, where quartz glass has gained acceptance in the field of gas discharge lamps and radio-frequency lamps. As a result of such a glass of “lower quality”, therefore, a disadvantage was deliberately accepted—counter to the trend in the prior art—in order to be able to realize the advantages mentioned.

Preferably, the average, predetermined loss factor tan δ is less than 100×10⁻⁴, more preferably less than 80×10⁻⁴, even more preferably less than 60×10⁻⁴, even more preferably less than or equal to 50×10⁻⁴. It is thereby possible to ensure, in particular, that the glass bulb is not heated, or not heated far beyond the required amount, which improves the efficiency of the radio-frequency lamps.

The loss factor tan δ of the glass of the glass bulb can be constant at least in sections and/or increase with increasing distance from the radio-frequency signal feeding device, in particular at least in sections continuously and/or in discrete steps. Alternatively or additionally, a thickness of the glass of the glass bulb can also be constant or increased with increasing distance from the radio-frequency signal feeding device, in particular at least in sections continuously and/or in discrete steps. The production outlay is reduced in the case of a constant design. A design with a varying thickness and/or a varying loss factor tan δ makes it possible that the temperature of the glass bulb in regions that are further away from the radio-frequency signal feeding device has an absolute value similar or (approximately) identical to that within regions in the vicinity of the radio-frequency signal feeding device or in the vicinity of or within the contact region. A temperature gradient can thus be reduced or even set to zero. An increase in the loss factor and/or the thickness can be linear, in particular. The loss factor and/or the thickness of the glass at a point that is furthest away from the radio-frequency signal feeding device can have a magnitude at least 1.5 times, more preferably at least 2 times, more preferably at least 3 times, the magnitude at a point that is closest to the radio-frequency signal feeding device, in particular lies within the contact region. By this means, too, it is possible to match the heating, for example within and outside the contact region, which improves the efficiency during the operation of the radio-frequency lamp. The risk of damage as a result of the comparatively high temperature gradient at the glass bulb can be reduced.

Alternatively, it can be provided that the loss factor tan δ of the glass of the glass bulb decreases with increasing distance from the radio-frequency signal feeding device, in particular at least in sections continuously and/or in discrete steps. Furthermore, a thickness of the glass of the glass bulb can also decrease with increasing distance from the radio-frequency signal feeding device, in particular at least in sections continuously and/or in discrete steps. A decrease in the loss factor and/or the thickness can be linear, in particular. The loss factor and/or the thickness of the glass at a point that is furthest away from the radio-frequency signal feeding device can have a magnitude at most 0.8 times, preferably at most 0.5 times the magnitude at a point that is closest to the radio-frequency signal feeding device, in particular lies within the contact region.

The loss factor tan δ can be calculated via the complex impedance Z or the phase shift φ between current and voltage within the glass bulb at radio-frequency as follows:

tan δ=tan ReZ/(ImZ);

tan δ=tan(90°−|φ|).

Re stands for real part.
Im stands for imaginary part.

In one preferred configuration, at least two, in particular two, radio-frequency signal feeding devices are provided, which are designed for feeding a radio-frequency signal of preferably 10 MHz to 100 GHz to in each case at least one contact region of the glass bulb and are preferably arranged opposite one another in such a way that the glass bulb lies (substantially) centrally between the radio-frequency signal feeding devices. The radio-frequency signal coupling-in can thereby be simplified. Furthermore, this measure also results in a temperature standardization (at least approximately). Overall, the efficiency of the radio-frequency lamp is improved again.

In a further preferred embodiment, an interspace is provided between the transparent housing, in particular in the second, outer glass bulb, and the first glass bulb. As a result, the heating process can be improved further, in particular since a thermal insulation is provided. As a result, the efficiency during the operation of the radio-frequency lamp can be increased further.

In an embodiment which is modified again and which is also claimed independently, the glass bulb is coated, in particular by vapor deposition, with an electrically conductive layer, in particular (thin) metal layer, at least in sections, in particular within an outer region lying outside the contact region. A “thin” metal layer or electrically conductive layer should be understood to mean a metal layer (hereinafter metal layer denotes an electrically conductive layer by way of example) having a layer thickness of in particular 10 nm to 1 μm, preferably 20 nm to 200 nm. In any case the metal layer should be so thin that the glass bulb is still optically transparent. The thin and optically transparent metal layer ensures that, at a predetermined distance from the contact region in which the radio-frequency signal is fed, an increased field strength is established and the glass bulb is thus heated comparatively uniformly. As a result, a temperature gradient can be reduced, which likewise reduces the risk of possible damage. In general, the efficiency of the radio-frequency lamp is increased as a result of this exception. In addition, the thin metal layer provides for shielding of the glass bulb. An undesired emission of the radio-frequency signal is damped. The (thin) conductive layer (metal layer) thus serves both for shielding and for heating of the radio-frequency lamp. As a result, one structural measure can simultaneously take account of two functions, which further reduces the production costs in a synergistic manner.

Preferably, a monofrequent or modulated and/or pulsed frequency can be fed by means of the radio-frequency signal feeding device. By way of example, a radio-frequency generator for generating the radio-frequency signal having the predetermined frequency can be provided. The glass bulb can be heated particularly efficiently by the use of the third harmonic. A radio-frequency amplifier possibly provided could be optimized for corresponding operation, such that, during the start phase of the radio-frequency lamp, an additional heating of the glass bulb takes place on account of the higher losses at the higher frequency. A further advantageous aspect of the use of the third harmonic is the easier ionization of the gases. As the frequency increases, demonstrably less energy has to be expended to ionize the metal salts, which in turn means a reduction of the required energy, which generally improves the efficiency of the radio-frequency lamp.

The above-mentioned problem is solved independently by a method for operating a radio-frequency lamp, in particular of the type described above, wherein a glass bulb is provided in such way, and a radio-frequency signal having at least one predetermined frequency and power is generated and fed to glass bulb in such a way, that the glass bulb is heated to a predetermined temperature at which a substance, in particular an ionizable salt, that is ionizable by the radio-frequency signal in the gaseous state is evaporated from an inner wall of the glass bulb. With regard to the advantages, reference is made to the radio-frequency lamp already described. In the method, too, a fundamental advantage can thus be seen in the fact that a radio-frequency signal can be used both for ionizing the luminophore and for heating the glass bulb.

Preferably, besides a fundamental frequency, in particular during a start phase, a third harmonic of the fundamental frequency is generated and fed. The start phase can last for example at least 5 seconds, in particular at least 20 seconds and/or at most 200 seconds, in particular 100 seconds.

Preferably, the predetermined temperature is at least 40° C., in particular 120° C., preferably 150° C., more preferably 200° C. As a result, an effective evaporation of the metal part can be ensured, which leads to economic operation of the radio-frequency lamp.

Preferably, the glass bulb is provided in such way and the radio-frequency signal having at least one predetermined frequency and power is generated and fed in such a way, that the predetermined temperature is substantially temporally and/or spatially constant, in particular a temporal and/or spatial variance of a predetermined spatial and/or temporal average value of the predetermined temperature is not greater than 30%, preferably 20%, more preferably 10%, even more preferably 5%. As a result of such temperature matching, a comparatively low average temperature can already lead to a sufficient evaporation of metal salt, which leads to efficient operation of the radio-frequency lamp.

The abovementioned problem is solved independently by the use of glass having a loss factor tan δ of at least 2×10⁻⁴; preferably at least 5×10⁻⁴; more preferably at least 20×10⁻⁴; even more preferably at least 50×10⁻⁴ for producing a glass bulb of a radio-frequency lamp, in particular of the type descried above, preferably for carrying out the method of the type described above. With regard to the advantages, reference is made to the method already described and the corresponding radio-frequency lamp.

The above-mentioned problem is furthermore solved independently by the use of a radio-frequency signal of preferably 100 MHz to 1000 GHz for heating a lamp bulb of a radio-frequency lamp, in particular of the type described above, preferably for carrying out the method of the type described above, in particular to at least 40° C., preferably at least 120° C., even more preferably at least 150° C.

The radio-frequency signal preferably has a frequency of 10 MHz to 100 GHz, in particular 300 MHz to 50 GHz, more preferably of 800 MHz to 10 GHz, even more preferably approximately 2 GHz to 3 GHz, even more preferably (approximately) 2.45 GHz.

Further embodiments are evident from the dependent claims.

The invention is described below including with regard to further features and advantages on the basis of exemplary embodiments that are explained in greater detail with reference to the following figures.

In the figures here:

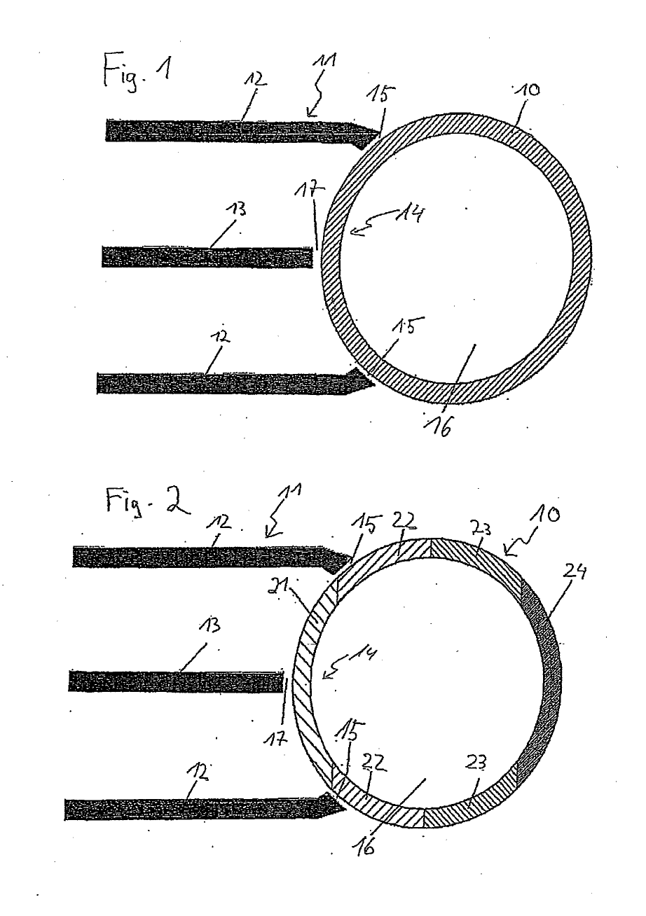

FIG. 1 shows a glass bulb according to the invention with a radio-frequency signal feeding device;

FIG. 2 shows a schematic illustration of a second embodiment of a glass bulb according to the invention with a radio-frequency signal feeding device;

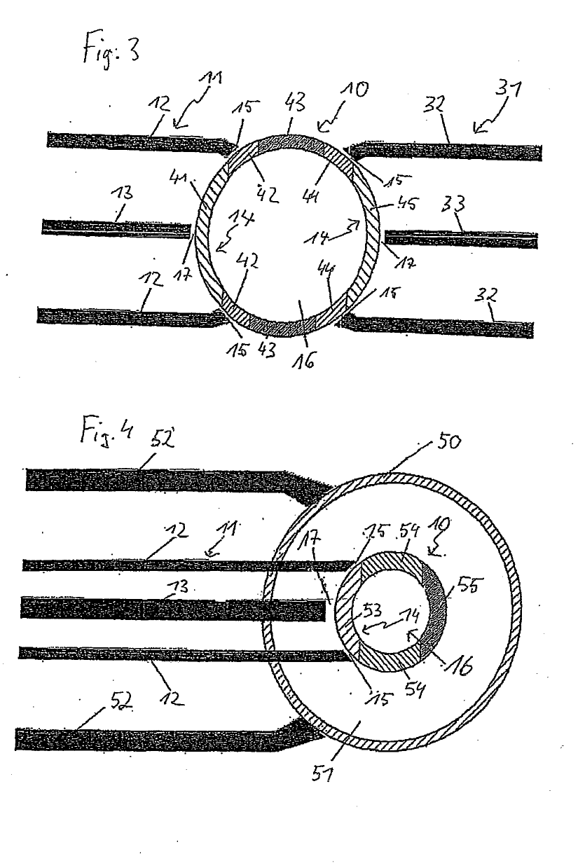

FIG. 3 shows a schematic illustration of a third embodiment of a glass bulb according to the invention with two radio-frequency signal feeding devices;

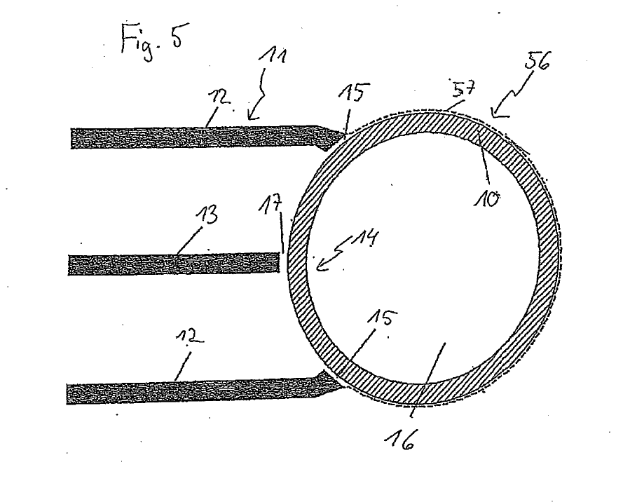

FIG. 4 shows a schematic illustration of a fourth embodiment of a glass bulb with a radio-frequency signal feeding device; and

FIG. 5 shows a schematic illustration of a fifth embodiment of a glass bulb with a radio-frequency signal feeding device.

In the following description, the same reference signs are used for identical and identically acting parts.

FIG. 1 shows a glass bulb 10 and a preferably shielded waveguide 11 of a radio-frequency lamp. The waveguide 11 comprises a preferably coaxial outer conductor 12 and an inner conductor 13, which is preferably round in cross section. The waveguide 11 can be shaped such that an impedance transformation, in particular in accordance with DE 10 2007 057 581 A1, is made possible. The radio-frequency signal is fed to the glass bulb 10 in a contact region 14, in which the waveguide 11 is in contact with the glass bulb 10. Provision can be made of an electrode, preferably metal electrode, which if appropriate is led through the glass bulb (not shown in the figures).

Only one type of glass is provided in the embodiment of the glass bulb 10 in accordance with FIG. 1. The thickness of the glass bulb 10 is constant (but in a departure from the figures can also vary). The use of a single type of glass allows comparatively cost-effective production. The waveguide 11, which constitutes a radio-frequency signal feeding device, realizes a radio-frequency heating that can be coupled with the driving for ionizing the salts in the interior of the glass bulb 10 in order to enable the operation of the radio-frequency lamp. In this case, an impedance transformation can be used for ionizing the gas and the same signal can be used for heating the glass wall. The waveguide 11 feeds the radio-frequency signal, preferably transformed beforehand, to the combustion chamber.

The glass bulb 10 can be fixed to the waveguide 11 preferably by means of an, in particular thermally insulating, connection location 15. Preferably, the thermal conductivity of the connection location 15 is less than 0.5 W/(mK), in particular less than 0.1 W/(mK). As a result of such a thermal insulation, the heating can be carried out more efficiently, which increases the efficiency of the radio-frequency lamp.

The radio-frequency signal can be fed to the glass bulb 10 or a (gas-filled) combustion chamber 16 within the glass bulb 10 by means of a capacitive coupling.

In this case, the glass bulb is heated to the greatest extent at a coupling-in location 17. Preferably, a temperature of at least 80° C., in particular at least 40° C., is nevertheless also achieved on the opposite side of the glass bulb 10. In this case, however, care should be taken to prevent the occurrence of excessively large temperature gradients, which could lead to destruction of the glass on account of stresses.

The feeding of the radio-frequency signal in FIG. 2 takes place in the same way as in FIG. 1. However, the glass bulb 10 in FIG. 2 is designed differently from FIG. 1. Here the glass bulb 10 is subdivided into a first glass bulb section 21, a second glass bulb section 22, a third glass bulb section 23 and a fourth glass bulb section 24. The first glass bulb section 21, which is situated in the contact region 14 or the region of the radio-frequency coupling-in, consists of a high-quality glass having a low loss factor tan δ of 1×10⁻⁴ to 1.5×10⁻⁴ for example. Glasses having higher loss factors are used with increasing distance from the waveguide 11. In the second glass bulb section, for example, a loss factor tan δ of 1.5×10⁻⁴ to 2×10⁻⁴ can be formed. In the third glass bulb section, the loss factor tan δ can be 2×10⁻⁴ to 3×10⁻⁴. In the fourth glass bulb section, the loss factor tan δ can be 3×10⁻⁴ to 5×10⁻⁴.

The radio-frequency signal radiates not only onto the glass of the glass bulb, but also simultaneously into the combustion chamber 16, in which the heated or evaporated gases are then ionized and the light emission is thereby initiated.

The subdivision of the glass bulb in regions having different loss factors can be effected, as in FIG. 2, discretely, into previously defined regions, but alternatively can also be embodied in a continuously variable manner. By means of a continuously variable embodiment, the wall temperature can be set particularly accurately, as a result of which, if appropriate, a uniform temperature of the wall can be achieved. However, a comparatively uniform temperature distribution can be achieved in the case of the discrete embodiment as well. It is thus possible to prevent a situation where a region of the radio-frequency lamp has an excessively low temperature and the lamp cannot be put into operation. On the other hand, it is possible to prevent a situation where the glass bulb becomes too hot locally and excessively great temperature gradients form which can lead to the destruction of the glass.

As a result, it is possible to reduce or avoid problems that may occur as a result of a local increase in the temperature in the vicinity of the radio-frequency coupling-in. In the case of a glass bulb embodied in a homogeneous fashion, a uniform temperature distribution should not be expected, in principle. The temperature is dependent on the distance from the coupling-in region. In this case, the “cold spot” (coldest point of the glass bulb) can be crucial for the operation of a radio-frequency lamp and should be expected for example opposite the coupling-in (in the case of coupling on one side) when a glass bulb 10 embodied in a spherical fashion is used. In the case of coupling on two sides (which will be described in greater detail below), the “cold spot” on the glass bulb should be expected in the middle between the coupling-in locations.

FIG. 3 shows an excerpt from an embodiment of the radio-frequency lamp in which, besides the glass bulb 10 and the first waveguide 11, a second waveguide 31 having an outer conductor 32 and an inner conductor 33 designed in accordance with the first waveguide 11 is provided. With regard to the design of the second waveguide 31 and of the first waveguide 11 (in accordance with FIG. 3), reference is made to the embodiments in accordance with FIGS. 1 and 2. The waveguides 11, 31 (in the other embodiments as well) can be driven with a differential technique in order to generate a local maximum of the field strength in the center of the combustion chamber 16 and simultaneously to heat the glass bulb on both sides.

In the initial example in accordance with FIG. 3, too, the glass bulb 10 is embodied inhomogeneously and comprises a first glass bulb section 41, a second glass bulb section 42, a third glass bulb section 43, a fourth glass bulb section 44 and a fifth glass bulb section 45, wherein preferably the first glass bulb section 41 and the fifth glass bulb section 45 consist of an identical material, and even more preferably the second glass bulb section 42 and the fourth glass bulb section 44 likewise consist of an identical material. The first glass bulb section 41 is situated in the contact region 14 of the first waveguide 11. The fifth glass bulb section is situated in the contact region 14 of the second waveguide 31. The first glass bulb section 41 and the fifth glass bulb section 45 are composed of a material having a comparatively low loss factor tan δ. The second glass bulb section 42 and the fourth glass bulb section 44, which directly adjoin the respective contact regions 14, are produced from a material having a higher loss factor tan δ. The third contact region 43, which lies between the second contact region 42 and the fourth contact region 44, has an even higher loss factor tan δ.

FIG. 4 shows an excerpt from a radio-frequency lamp, wherein the first glass bulb 10 is provided within a second glass bulb 50. An interspace 51 between second glass bulb 50 and first glass bulb 10 is preferably evacuated or evacuatable. As a result, the heating process can be additionally supported, which enables economic operation of the radio-frequency lamp. The second glass bulb 50 is held by a mount, in particular an outer housing 52. The second glass bulb 50 can be satin-frosted or clear. The radio-frequency signal can be fed to the first glass bulb 10 via the waveguide 11 or the outer conductor 12 and inner conductor 13 thereof, analogously to FIGS. 1 and 2. The first glass bulb 10 in accordance with FIG. 4 consists of a first glass bulb section 53, a second glass bulb section 54 and a third glass bulb section 55, the loss factors thereof increasing in the stated order. The third glass bulb section 55 is arranged opposite the first glass bulb section 53, which is in turn arranged in the contact region 14. The second glass bulb section 54 is arranged between the first glass bulb section 53 and the third glass bulb section 55. The evacuated interspace 51 ensures a thermal insulation of the first glass bulb 10. The embodiment in accordance with figure can also be extended to driving on two sides, as shown in FIG. 3.

The embodiment in accordance with FIG. 5 substantially corresponds to the embodiment in accordance with FIG. 1, but a (thin) metal layer 57 is vapor-deposited on the glass bulb 10 in an outer region 56 situated outside the contact region 14. The (thin) metal layer 57 can preferably be electrically connected to the outer conductor 12 of the waveguide 11, wherein the outer conductor 12 is furthermore preferably connected to ground (which can also be the case in the other embodiments). The (thin and optically transparent) metal layer 57 makes it possible that, at a certain distance from the contact region 14, an increased field strength is established and the glass is thus heated comparatively uniformly. Moreover, said (thin) metal layer 57 enables the lamp to be shielded. An emission of the radio-frequency signal is thereby damped.

The losses and thus also the heating of the glass bulb are dependent on the loss factor tan δ of the glass and on the frequency. The use of the third harmonic results in a further possibility of influencing the increase in temperature of the glass bulb. A radio-frequency amplifier provided could be optimized to corresponding operation, such that an additional heating of the glass bulb 10 can take place during a start phase of the radio-frequency lamp, on account of the then higher losses at the higher frequency.

A further advantage of using the third harmonic is an easier ionization of the gases. As the frequency increases, less energy has to be expended to ionize the metal side, which in turn means that the required energy is reduced.

Compared with the radio-frequency antenna lamps mentioned in the introduction, in the case of the radio-frequency lamps described here, less (almost no) radio-frequency emission takes place and the lamp is able to be approved. Furthermore, the efficiency can be improved. The radio-frequency load (of the filled glass bulb) has comparatively high impedance, thus resulting, upon matching, in very high electric field strengths with low powers.

The heating of the glass bulb of the radio-frequency lamp is realized by a microwave being radiated in on one or two sides. The temperature gradients on the wall of the glass bulb can be minimized, such that the temperature of the entire wall of the glass bulb is distributed comparatively homogeneously.

The radio-frequency lamp can be used for the construction of microwave-driven (radio-frequency-driven) discharge lamps suitable, in particular, for improving the properties with regard to efficiency, emission spectrum, costs, longevity and sustainability.

On account of its multi-line spectrum, the radio-frequency lamp is particularly well suited to use as a light source in private households.

The microwave-driven radio-frequency lamp can be fabricated very inexpensively by means of radio-frequency electronic components available comparatively cost-effectively on account of the telecommunications market, and by means of customary gas discharge lamp technology, especially since the high-voltage requirements are significantly lower in comparison with traditional starter circuits.

It should be pointed out at this juncture that all parts described above as considered by themselves and in any combination, in particular the details illustrated in the drawings, are claimed as essential to the invention. Modifications thereof are familiar to a person skilled in the art.

### LIST OF REFERENCE SIGNS

10 Glass bulb
11 Radio-frequency signal feeding device (waveguide)
12 Outer conductor
13 Inner conductor
14 Contact region
15 Connection location
16 Combustion chamber
17 Coupling-in location
21 First glass bulb section
22 Second glass bulb section
23 Third glass bulb section
24 Fourth glass bulb section
31 Second waveguide
32 Outer conductor
33 Inner conductor
41 First glass bulb section
42 Second glass bulb section
43 Third glass bulb section
44 Fourth glass bulb section
45 Fifth glass bulb section
50 Second glass bulb
51 Interspace
52 Housing
53 First glass bulb section
54 Second glass bulb section
55 Third glass bulb section
56 Outer region
57 Metal layer

1. A radio-frequency lamp, comprising
at least one glass bulb and at least one radio-frequency signal feeding device for feeding a radio-frequency signal having a predetermined frequency of from 10 MHz to 100 GHz to at least one contact region of at least one glass bulb, wherein the glass bulb contains a substance that is ionizable by the radio-frequency signal in the gaseous state, and said glass bulb at least in sections consists of a glass that has on average a loss factor tan δ of at least 2×10⁻⁴, measured at a reference temperature of 20° C. and with a reference signal of 1 MHz, wherein a transparent housing is provided, in which the first glass bulb is arranged.

2. The radio-frequency lamp as claimed in claim 1, wherein the average, predetermined loss factor tan δ is less than 100×10⁻⁴, preferably less than 80×10⁻⁴.

3. The radio-frequency lamp as claimed in claim 1, wherein the loss factor tan δ and/or the thickness of the glass of the glass bulb are/is constant at least in sections or increase(s) with increasing distance from the radio-frequency signal feeding device.

4. The radio-frequency lamp of claim 1 wherein the loss factor tan δ and/or the thickness of the glass of the glass bulb at a point that is furthest away from the radio-frequency signal feeding device have/has a magnitude at least 1.5 times the magnitude at a point that is closest to the radio-frequency signal feeding device lying within the contact region.

5. The radio-frequency lamp of claim 1 further comprising at least two radio-frequency signal feeding devices, which are designed for feeding a radio-frequency signal of preferably 10 MHz to 100 GHz to in each case at least one contact region of the glass bulb and are preferably arranged opposite one another in such a way that the glass bulb lies substantially centrally between the radio-frequency signal feeding devices.

6. The radio-frequency lamp of claim 1 further comprising an interspace between the transparent housing and the first glass bulb is evacuatable or evacuated.

7. The radio-frequency lamp of claim 1 wherein the glass of the glass bulb is coated with an electrically conductive layer of thin metal at least in sections within an outer region lying outside the contact region.

8. The radio-frequency lamp as claim 1 further comprising a radio-frequency generator for generating the radio-frequency signal having the predetermined frequency, wherein the frequency is monofrequent or modulated and/or pulsed.

9. A method for operating the radio-frequency lamp of claim 1 wherein a glass bulb (10) is provided in such way, and a radio-frequency signal having at least one predetermined frequency and power is generated and fed to the glass bulb in such a way, that the glass bulb is heated to a predetermined temperature at which a substance that is ionizable by the radio-frequency signal in the gaseous state is evaporated from an inner wall of the glass bulb.

10. The method as claimed in claim 9, wherein at least one of a monofrequent, modulated and pulsed radio-frequency signal is generated and fed as the radio-frequency signal.

11. The method as claimed in claim 9 wherein the predetermined temperature is at least 40° C.

12. The method as claimed in claim 9 wherein the glass bulb is provided in such way and the radio-frequency signal having at least one predetermined frequency and power is generated and fed in such a way, that a temporal and/or spatial variance of a predetermined spatial and/or temporal average value of the predetermined temperature is less than 30%.

13. A glass bulb for a radiofrequency lamp wherein the glass has a loss factor tan δ of greater than 2×10⁻⁴, the glass bulb having at least one contact region and contains a substance that is ionizable by a radio-frequency signal in the gaseous state.

14. The method of claim 9 in which the radio-frequency signal heats a lamp bulb to at least 40° C.
